(19) United States
(12) Patent Application Publication
(10) Pub. No.: US 2016/0265206 A1
(43) Pub. Date: Sep. 15, 2016

(54) PUBLIC PRIVACY DEVICE

(71) Applicant: Georgia White, Sandy, UT (US)

(72) Inventor: Georgia White, Sandy, UT (US)

(21) Appl. No.: 15/065,649

(22) Filed: Mar. 9, 2016

Related U.S. Application Data
(60) Provisional application No. 62/130,462, filed on Mar. 9, 2015.

(51) Int. Cl. E03D 9/04; G10K 11/175; E03D 9/00

(52) U.S. Cl. CPC E03D 9/04; E03D 9/007; G10K 11/175; G10K 2210/12; G10K 2210/109

(57) ABSTRACT

Embodiments of a restroom privacy system include an intake to mount to a wall of a restroom to receive contaminated air from the restroom stall, a fan to draw the contaminated air in at the intake, an exhaust port to allow exhaust air to pass from the fan out of the system, and a noise production unit to provide auditory privacy, the noise production unit configured to produce noise cancellation in response detecting a sound within the restroom.

### CROSS-REFERENCE TO RELATED APPLICATIONS

This application claims the benefit of U.S. Provisional Patent Application Ser. No. 62/130,462 filed on Mar. 9, 2015, and entitled “Public Privacy Device,” the contents of which are hereby incorporated by reference herein.

### BACKGROUND

Using a restroom can be an uncomfortable and unpleasant experience. Sounds and smells generated by private activity in a public restroom can be embarrassing and repulsive. While in the restroom, users may not want to be heard and may not want to hear others. Additionally, users generally prefer to not share their smell and prefer not to smell others. Because public restrooms frequently include hard surfaces for ease of cleaning, sounds are not easily controlled. Bathrooms can be quite loud to the point of seeming to amplify sounds made within stalls. Additionally, the stalls themselves offer no real sound or smell control. Stalls are typically constructed of hard planar surfaces with substantial gaps above and below the walls. As such, stalls offer only a minimum of visual privacy while providing no control over sound and smell. This may make the use of public facilities uncomfortable and embarrassing.

### SUMMARY

Embodiments of a restroom privacy system are described. In one embodiment, the restroom privacy system includes an intake to mount to a wall of a restroom to receive contaminated air from the restroom stall, a fan to draw the contaminated air in at the intake, an exhaust port to allow exhaust air to pass from the fan out of the system, and a noise production unit to provide auditory privacy, the noise production unit configured to produce noise cancellation in response detecting a sound within the restroom. Other embodiments of a restroom privacy system are described.

Embodiments of a method for providing privacy in a restroom are described. In one embodiment, the method for providing privacy in a restroom includes installing a fan on a wall of a restroom, drawing air from a first side of the wall through an air transfer port of a panel attached to the wall, exhausting the air through an exhaust port to a second side of the wall, and detecting through a sound detector connected to the panel a sound within the restroom and generating a noise cancellation to mask the sound within the restroom to provide auditory privacy. Other embodiments of a method for providing privacy in a restroom are described herein.

Other aspects and advantages of embodiments of the present invention will become apparent from the following detailed description, taken in conjunction with the accompanying drawings illustrated by way of example of the principles of the invention.

### BRIEF DESCRIPTION OF THE DRAWINGS

FIG. 1 depicts a schematic diagram of one embodiment of a restroom privacy system in a stall door.

FIG. 2 depicts a block diagram of one embodiment of a restroom privacy system.

FIG. 3A depicts a schematic diagram of one embodiment of a front panel of a restroom privacy system.

FIG. 3B depicts a schematic diagram of another embodiment of a front panel of a restroom privacy system.

FIG. 4 depicts a cross-sectional diagram of one embodiment of a restroom privacy system in a stall door.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments provide for privacy in at least one aspect while in a public restroom. Some embodiments provide for auditory privacy by generating a noise to mask or cancel sounds made in the restroom, public or private. The noise may be generated by running a fan or through electronic noise generation. An embodiment using the fan may also provide for evacuation of contaminated air from the stall. The air may be evacuated through a filter, or treated with a sanitizer and/or scent. The system may be hardwired to a central electrical system or it may include a battery or other local power source.

The system may be installed into a stall door or wall, incorporated into a toilet paper dispenser or other stall hardware, or as a standalone unit. While some embodiments can be mounted into the stall door or wall, visual privacy is not compromised by installation as the unit does not provide visual pass-through. In some embodiments, the system may be installed in a home or private bathroom, in a wall or ceiling, or incorporated into a toilet paper dispenser or other hardware.

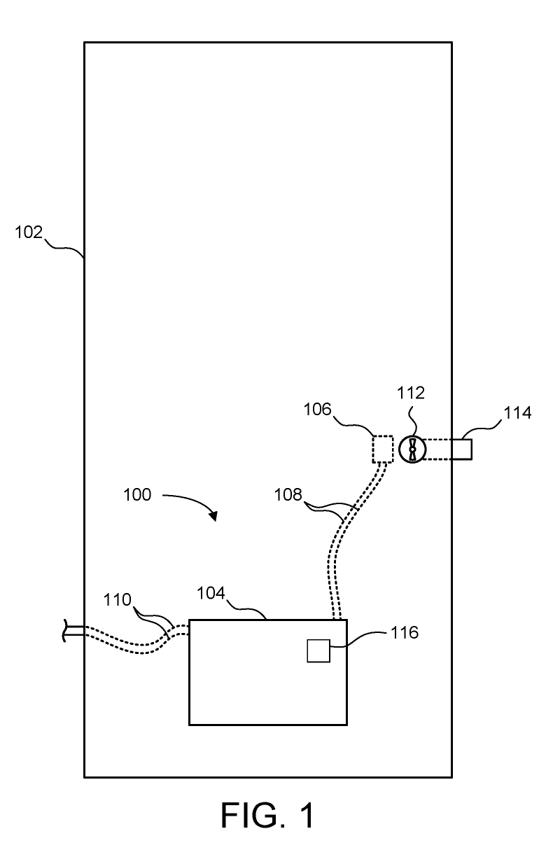

FIG. 1 depicts a schematic diagram of one embodiment of a restroom privacy system 100 in a stall door 102. In the illustrated embodiment, the privacy system 100 includes a panel 104, a switch 106, switch leads 108, and power leads 110, and a relay system 116. The door 102 includes a handle 112 and a bolt 114.

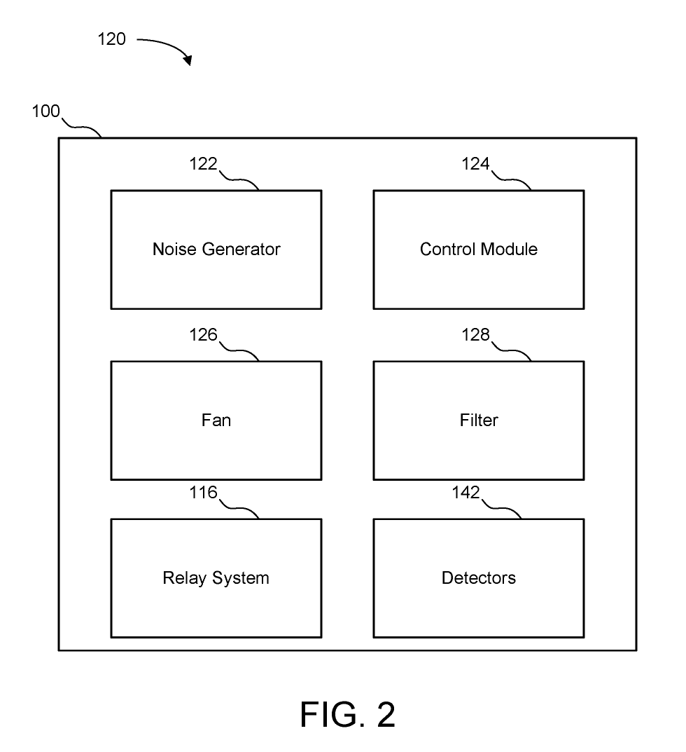

In the illustrated embodiment, the panel 104 is installed into the door 102. The door 102 may be a partitioned wall or door in a public restroom or some other location. In other embodiments, the door 102 may be a wall or ceiling of a private bathroom, or a vanity or cupboard. The panel 104 may be flush mounted or surface mounted on the door 102. In some embodiments, the panel 104 provides multiple functions. In some embodiments, the panel 104 includes noise generation functions to generate a privacy noise. The noise may be a white noise, anti-phase noise, or some other noise sufficient to cancel or mask noises coming from within the stall or from outside of the stall, or in the case of a private bathroom the noise will cancel or mask noises coming from within a bathroom or from outside of the bathroom. The noise may be generated by an electronic noise generator (described in more detail with reference to FIG. 2). In another embodiment, the noise may be generated by a fan incorporated into the panel 104.

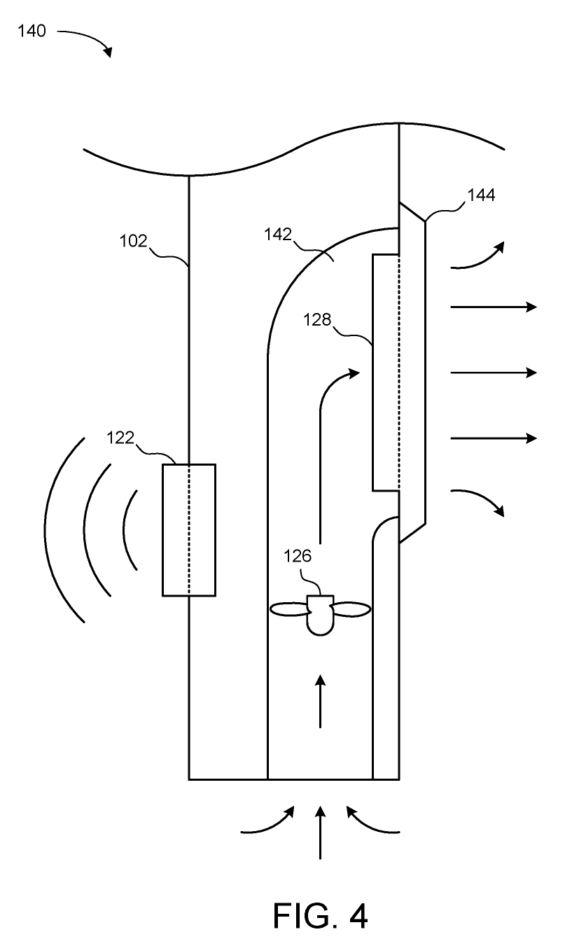

The panel 104 may include a fan or air handler (described below with reference to FIGS. 2 and 4) to move air through the panel 104. In some embodiments, the panel 104 draws contaminated air from one side of the door 102 and exhausts it outside of the stall. The panel 104 may include an exhaust port on the other side of the door 102.

In some embodiments, the panel 104 is connected to a switch 106 by switch leads 108. In some embodiments, the switch 106 detects a closed or open status of the door 102. This may be accomplished by interaction between the switch 106 and the door handle 112. For example, the bolt 114 of the door handle 112 may contact or interact with the switch 106 in a certain manner when the bolt 114 is in the drawn position or in the thrown position. The interaction may be magnetic, electronic, optical, proximity-based, mechanical, or a combination of these or other manners of detection.

In another embodiment, the switch 106 may detect an occupied state of the stall through motion detection or some other manner. Motion detection may allow the panel 104 to operate without requiring physical contact from a stall user. This would improve sanitation and prevent the spread of contaminants. In some embodiments, the motion detection may initiate the noise cancellation and may only operate the air filtering or fan once the motion detector ceases to detect motion within the specified area. Such embodiments would only operate the fan once a user has left the bathroom or stall and the motion detector ceases to detect motion.

Upon meeting a condition, the switch 106 may send a signal along the leads 108 to the panel 104 to commence or cease operation. In another embodiment, the switch 106 may be a sound detector to detect a sound and trigger the panel 104. For example, the switch 106 may be a sensor for a noise cancelation operation of the panel 104. When the switch 106 detects a noise, the noise is analyzed, and the panel 104 produces a canceling noise corresponding to the detected noise to effectively cancel out the noise.

While the illustrated embodiment includes leads 108 and 110, some embodiments, operate on a wireless communication. In other embodiments, the components of the system 100 may be located in a single package to simplify the system 100. Other embodiments may include other arrangements of parts and manners of communicating between components.

In one embodiment, the switch 106 may detect a decibel level of a sound to calculate the volume level of a masking noise generated by the panel 104. For example, the switch 106 may detect a certain noise level and communicate that level to the panel 104 which adjusts the volume of generated noise to effectively mask the detected noise level. This could be done by adjusting an electronic noise generator or changing a power level of a fan or both. Other embodiments may execute other forms of noise customization. Additionally, some embodiments may include fewer or more sensors to detect other factors or environmental components.

In the illustrated embodiment, the panel 104 is connected to electrical power via the power leads 110. The power leads 110 may be connected to a local electrical grid to provide power to the panel 104. In other embodiments, the panel 104 includes an independent power source such as a battery, solar panel, or other source of electrical power. In some embodiments, the panel 104 may include a mechanical power generation means. For example, the action of shutting the door 102 may generate an electrical charge sufficient to run the panel 104 for several minutes (approximately the time one would occupy the stall). Other embodiments may use other ways of supplying power to the panel 104.

FIG. 2 depicts a block diagram 120 of one embodiment of a restroom privacy system 100. The illustrated embodiment of the privacy system 100 includes a noise generator 122, a control module 124, a fan 126, and a filter 128.

In one embodiment, the noise generator 122 is an electronic or mechanical noise generator. For example, the noise generator 122 may include a sound speaker to generate noise such as white noise, canceling noise, or other sound patterns. The noise generator 122 may be coupled to the control module 124. The control module 124 may control power, volume, pattern, phase, frequency, or tone of the noise generator 122. Other embodiments may include more or less interaction between the noise generator 122 and the control module 124.

In another embodiment, the noise generator 122 is coupled to the fan 126 to generate noise. In the illustrated embodiment, the noise generator 122 is separate from the fan 126. In another embodiment, the fan 126 accomplishes the function of the noise generator 122 and the noise generator 122 is omitted. In another embodiment, the noise generator 122 includes the fan 126 in generating noise. For example, the noise generator 122 may control the fan 126 to produce the proper noise level indicated by the control module 124. In another embodiment, the noise generator 122 may supplement noise the generator 122 generates by creating additional noise with the fan 126.

The fan 126 may be a traditional blade fan of any number, size, and pitch of blades. Other embodiments may include centrifugal fans, screw-type fans, or other types of air handlers. In some embodiments, the fan 126 is controlled by the control module 124. The control module 124 may control power to the fan 126 and adjust fan speed based on a parameter from a sensor or a parameter pre-programmed into the control module 124. Other inputs may be accepted by the control module 124 for management of the privacy system 100.

In some embodiments, the fan 126 drives air to the filter 128. In some embodiments, the filter 128 may filter out undesirable components from the air. The filter 128 may be a traditional media filter, an electronic filter, or other type of filter. For example, the filter 128 may be a replaceable or washable cotton filter. The filter 128 may also include a UV light or other sterilizer. The filter 128 may also be an electronic ionizer. Other types of filters may be incorporated. Additionally, multiple types of filters may be used together. In some embodiments, the control module 124 in connected to the filter 128 to monitor the filter or control a feature or aspect of the filter 128. For example, the control module 124 may activate a feature such as UV lights, scent application, ionization, or other functionality.

In some embodiments, the filter 128 may apply a component to the air passing through the privacy system 100. For example the filter 128 may apply a scent component. The filter 128 may be situated ahead of the fan 126 in the air flow or after the fan 126. Some embodiments may have a filter 128 ahead of the fan 126 and after the fan 126. In some embodiments, the filter 128 is removable for replacement or maintenance. In other embodiments, the filter 128 is fixed within the system 100. Other embodiments may incorporate or apply the filter 128 in different ways.

While the system 100 has been described with certain elements operating or interacting in certain ways. Other embodiments of the system 100 may include fewer or more components to achieve less or more functionality. In some embodiments, the combination of features into a single unit is desirable and unique, combining the noise cancellation/generation function with the air filtering, and scent release into a single unit that can be easily mounted to a bathroom stall or in a private bathroom. Additionally, the compactness of the unit allows for easy installation in multiple stalls of a bathroom and potentially every stall in a bathroom. This aids in applying specific remedies in each stall.

Some embodiments include a relay system 116. Many fans today are operated by switch. In such configurations, a user may turn the switch upon leaving a bathroom to turn off the lights and the fan. The fan ceases to operate while the user is not in the bathroom. Otherwise the user will leave the switch on and leave a fan operating and will have to come back later to turn off the fan or worse yet leave the fan going and thus waste energy. In some implementations of the system 100, a relay system 116 is included that operates the fan 126 and/or filter 128 even after the user has left the bathroom and turned off the lights. In some embodiments, the relay system is integrated with a light switch in a bathroom and initiates the system 100 and its functions once the light switch is turned off and the user has exited the bathroom. In some embodiments, the system 100 automatically turns off after a period of time, and thus eliminates wasting energy.

Some embodiments of the system 100 include detectors 142. The detectors 142 may be motion detectors, sound detectors, odor detectors which may be integrated to the other features of the system 100 and may trigger the fan 126, filter 128, noise generator 122, and/or a fragrance emitter depending on a condition of the detectors 142. Odor detectors may include a chemoreceptor, a chemosensor, or other types of sensory receptors, or may analyze composition by gas chromatography.

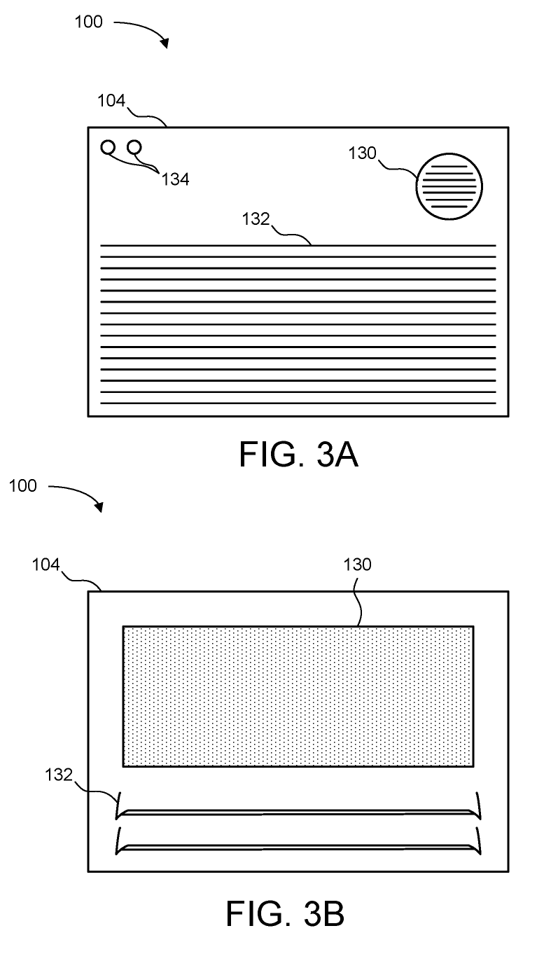

FIG. 3A depicts a schematic diagram of one embodiment of a front panel 104 of a restroom privacy system 100. In the illustrated embodiment, the privacy system 100 includes a front panel 104 with a noise generator port 130, an air transfer port 132, and electronics 134.

In some embodiments, the panel 104 is visible on the inside of the door of a stall after the system 100 is installed. The panel 104 may be made of plastic, metal, or some other material. The panel 104 may range in size from relatively small to dimensions closer to those of a standard bathroom stall door or wall. In the illustrated embodiment, the panel 104 is rectangular. Other embodiments may include a panel 104 that is round, oval, square, triangular, or of some other geometry. In some embodiments, the panel 104 is not visible in the door except for one or more of the noise generator port 130, the air transfer port 132, and the electronics 134. In another embodiment, the panel 104 may not be visible to a stall user at all (one embodiment described below with reference to FIG. 4).

In the illustrated embodiment, the panel 104 includes a noise generator port 130. The noise port 130 is shown as round but may be some other shape. In some embodiments, the noise port 130 allows a masking or cancelling noise to be transmitted out of the panel 104. In some embodiments, the noise port 130 has a directional aspect to direct the noise from the noise port 130 in a certain direction. The noise port 130 may also be configured to transmit diffuse noise. The noise port 130 may also be removable relative to the panel 104. This may facilitate maintenance or repairs. In other embodiments, the noise port 130 may be integral with the panel 104 to prevent tampering. The noise port 130 may include water-resistant qualities, dust resistance, or other qualities that may protect the noise generator (not shown) or other internal or external components of the panel 104. In some embodiments, the noise port 130 is combined in a unified structure with the air transfer port 132.

The air transfer port 132 is shown as a series of horizontal lines depicting horizontal openings in the panel 104 to facilitate air flow. In some embodiments, the air transfer port 132 may include other opening structures or orientations. The air transfer port 132 is shown, in FIG. 3, as being located near a lower edge of the panel 104. In other embodiments, the air transfer port 132 is situated in another portion of the panel 104. In some embodiments, the air transfer port 132 may take up more or less of the surface area of the panel 104. For example, the air transfer port 132 may cover the entire surface of the panel 104 with other components integrated into the air transfer port 132. The air transfer port 132 may be made of the same or different materials from those used to make the panel 104 or components of the panel 104. The air transfer port 132 may also have a directional component to direct incoming air in a certain manner. The air transfer port 132 may also be oriented in such a way as to provide visual privacy to a stall user. For example, the air transfer port 132 may be angled to prevent visual pass-through at the panel 104. In another embodiment, the air transfer port 132 may be offset from an exhaust port (not shown) on the opposite side of a stall door or wall so as to prevent visual pass-through. Other embodiments may include other features incorporated in the air transfer port 132.

The illustrated embodiment of the panel 104 also includes the electronics 134. In some embodiments, the electronics 134 are sensors, buttons, switches, indicators, or another electronic component to detect, interface with, or communicate information to a stall user. For example, the electronics 134 may be motion sensors or another type of sensors, indicator lights, on/off, volume, or speed control buttons, or a mixture of multiple types of electronic or mechanical components. The electronics 134 are illustrated as being separated from the noise port 130 and the air transfer port 132 on the panel 104. In other embodiments, the electronics 134 are integrated with one or more of the other components of the panel 104. Other embodiments may include fewer or more electronics 134 to provide more or less functionality.

FIG. 3B depicts a schematic diagram of one embodiment of a front panel 104 of a restroom privacy system 100. The illustrated embodiment includes a front panel 104, a noise generator port 130, and an air transfer port 132. The illustrated embodiment is similar in function to that of the system 100 of FIG. 3A. In this embodiment, the panel 104 is simplified and includes a different format for the noise generator port 130 and the air transfer port 132. Other embodiments may include other arrangements or variations on the format or appearance of the features of the panel 104.

FIG. 4 depicts a cross-sectional diagram of one embodiment of a restroom privacy system 140 in a stall door 102. The illustrated embodiment includes a door 102 with an internal channel 142, a noise generator 122, a fan 126, a filter 128, and an exhaust port 144.

In the illustrated embodiment, the door 102 has been modified to accept the components of a privacy system. In the illustrated embodiment, the door 102 includes an internal channel 142. The internal channel 142 may be a channel that existed in the door 102 or was retrofitted into the door 102 during an installation process. In the illustrated embodiment, the fan 126 is inside the channel 142. The channel 142 may be a complete enclosed channel or a partial channel. For example, the channel 142 may have a small portion leading up to the fan with an opening in the back of the door 102 for the exhaust port 144. The channel 142 may also be an enclosing structure to define an enclosed space in which the fan 126 fits and directs air along a guided path from an intake opening to the exhaust port 144.

In the illustrated embodiment, the channel 142 enters through the bottom of the door 102, turns, and exits at a side panel of the door 102. In other embodiments, the channel 142 may exit at the top of the door 102. For example, the channel 142 may be aligned to direct air towards a central air evacuation system in a restroom. The channel 142 may allow for transport of the air to another system or exhaust.

The filter 128 is shown as located downstream from the fan 126.

However, the filter 128 may be located upstream or downstream from the fan 126. In some embodiments, multiple filters 128 may be located upstream and/or downstream of the fan 126. As described above, the filter 128 may include electronic components, scent components, filtration media, or other functional components.

The exhaust port 144 is shown as attached to the outside of the stall door 102. In some embodiments, the exhaust port 144 is similar to the air transfer port 132 described above with reference to FIG. 3. Even if the exhaust port 144 were open to maximize air flow, in the illustrated arrangement, the channeled design allows for air transfer without compromising visual privacy.

The noise generator 122 is shown as mounted into the inside of the stall door 102 so as to be on the same side of the door 102 as the stall user. The noise generator 122 is described above with reference to FIG. 2. In some embodiments, the noise generator 122 may be located on the underside or opposite side of the door 102 from the illustrated embodiment. In some embodiments, a location for the noise generator that is not visible from the stall user's perspective may reduce suspicion of recording devices or other nefarious purposes. In the embodiment in which the noise generator 122 is located in a portion of the underside of the door 102 (for example, next to the intake of the channel 142), the system 140 may avoid unfamiliar structures within the sight of the stall user. Other embodiments may include masks to hide a component of the system 140 or other manners of avoiding unpleasant suspicions.

While many of the embodiments described above relate to public privacy system which may be retrofitted into existing stall doors or walls, many embodiments may be built into doors or walls at the point of manufacture. For example, a stall wall may be built with the privacy system incorporated into the door. In some embodiments, specific doors, walls, or restroom components may be built to accommodate the systems described above. In some embodiments, the system may be attached to a wall and exhaust the air outside the bathroom itself.

Some embodiments of the system may include aesthetic coverings to hide the system from view or to include or simulate high quality or luxury materials. The system may be incorporated into a sleek minimalist design. In some embodiments, the system may be aesthetically matched to a decor or motif of a restroom. For example, if the restroom includes brushed stainless steel in the design, the system may include a brushed stainless finish. The system may include a paint-ready finish to facilitate painting to match a door, wall, or other component within a restroom.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for providing privacy in a restroom, the method comprising:
installing a fan on a wall of a restroom;
drawing air from a first side of the wall through an air transfer port of a panel attached to the wall;
exhausting the air through an exhaust port to a second side of the wall; and
detecting through a sound detector connected to the panel a sound within the restroom and generating a noise cancellation to mask the sound within the restroom to provide auditory privacy.

2. The method of claim 1, wherein generating the noise to mask the sound comprises generating the noise at the fan.

3. The method of claim 1, wherein generating the noise to mask the sound comprises generating the noise at an electronic noise generator.

4. The method of claim 1, further comprising filtering the air.

5. The method of claim 1, further comprising applying a scent to the air in response to detecting an odor from an odor detector.

6. The method of claim 1, wherein the wall is a partitioned wall of a stall in the restroom, and wherein exhausting the air through the exhaust port comprises exhausting the air to a second side of the partitioned wall within the restroom.

7. The method of claim 1, further comprising initiating the fan in response to detecting motion from a motion detector to draw the air from the first side of the wall through the air transfer port of the panel.

8. The method of claim 1, further comprising initiating the fan in response to a motion detector detecting motion for a period of time followed by ceasing to detect motion for a period of time.

9. A restroom privacy system comprising:
an intake to mount to a wall of a restroom to receive contaminated air from the restroom stall;
a fan to draw the contaminated air in at the intake;
an exhaust port to allow exhaust air to pass from the fan out of the system; and
a noise production unit to provide auditory privacy, the noise production unit configured to produce noise cancellation in response detecting a sound within the restroom.

10. The system of claim 9, wherein the fan is a part of the noise production unit to provide auditory privacy.

11. The system of claim 9, wherein the noise production unit comprises an electronic noise generator.

12. The system of claim 9, further comprising a filter to filter the contaminated air.

13. The system of claim 9, further comprising a scent applicator to apply a scent to the air in response to an odor detector detecting an odor.

14. The system of claim 9, further comprising a motion detector configured to detect motion, wherein the fan is configured to initiate in response to detecting a motion in the restroom.

15. The system of claim 9, further comprising a motion detector configured to detect motion, wherein the fan is configured to initiate in response to detecting motion for a period of time followed by ceasing to detect motion for a period of time.

16. The system of claim 9, wherein the wall is a partitioned wall of a stall in the restroom.

17. The system of claim 9, wherein the noise production unit is separate from the fan.
